(19) United States
(12) Patent Application Publication
(10) Pub. No.: US 2017/0324438 A1
(43) Pub. Date: Nov. 9, 2017

(54) LIGHTING DEVICE WITH LIGHTS ON ROTATABLE PANELS FOR MOBILE ELECTRONIC DEVICES

(71) Applicant: R.A.M. INNOVATIONS, LLC, Dobbs Ferry, NY (US)

(72) Inventor: Aaron Mischel, Thousand Oaks, CA (US)

(21) Appl. No.: 15/499,814

(22) Filed: Apr. 27, 2017

Related U.S. Application Data
(60) Provisional application No. 62/331,556, filed on May 4, 2016.
(60) Provisional application No. 62/474,487, filed on Mar. 21, 2017.

(51) Int. Cl. H04B 1/3888; H05B 33/08; F21V 33/00; F21S 9/02; H04N 5/247; H04N 5/225; F21V 14/02; H05B 37/02; F21V 3/00; H04W 4/00; F21Y 2115/15; F21Y 2115/10

(52) U.S. Cl. CPC H04B 1/3888; H05B 37/0272; H05B 33/0845; F21V 33/0052; F21S 9/02; F21V 3/00; H04N 5/247; H04N 5/2256; F21V 14/02; F21Y 2115/15; F21Y 2115/10; H04W 4/008

(57) ABSTRACT

A photography lighting device that provides a lighting source to a mobile electronic device. The mobile electronic device includes a front facing camera and a rearward facing camera. The lighting device includes a first light source movable from a first position to a second position. The first light source is rearward facing in the first position to provide illumination for the rearward facing camera. The first light source is forward facing in the second position to provide illumination for the forward facing camera. The lighting device further includes a second light source movable from a first position to a second position. The second light source is rearward facing in the first position to provide illumination for the rearward facing camera. The second light source is forward facing in the second position to provide illumination for the forward facing camera.

### CROSS REFERENCE TO RELATED APPLICATIONS

This application claims the benefit of U.S. Provisional Application Nos. 62/331,556, filed May 4, 2016, and 62/474,487, filed Mar. 21, 2017; all of which are incorporated by reference herein in their entirety.

### BACKGROUND

The present disclosure relates to cases and/or lighting devices for mobile electronic devices.

Mobile electronic devices such as tablets, laptops, personal computers, iPod Touch, digital cameras, and mobile phones can include on-board camera lenses. These camera lenses are now commonly both rearward facing (away from the mobile device's user interface and screen), and forward facing (in the same direction as the user interface and screen). Many mobile devices not only include camera functions (or “Apps”), but also include video. Some mobile devices include “mirror” functions (looking at oneself in the screen like using a mirror).

The quality of cameras and video of mobile devices has improved dramatically, and has all but eliminated the need to carry around or use a traditional camera or video device. When in dark or poor light situations, the camera, video, video chat, mirror or other image function (hereinafter “imaging functions”) have made use where possible of an onboard light source such as LED or LED cluster. Moreover, their light is relatively harsh resulting in poor quality photography.

There is a need for an improved lighting device for providing better quality illumination for mobile devices having rearward facing and/or forward facing cameras.

### SUMMARY

In accordance with one embodiment, there is a mobile device case, such as for a mobile phone, which has lighted panels (or flaps) that fold inwardly from an edge of the case (preferably over the rear of the phone). The panels can be biased open or held open preferably to 180 degrees or substantially 180 degrees, i.e., to a point where light coming from the panels will be directed toward a subject in front of the mobile device. The panels can be held closed by a locking mechanism over the back of the phone or device. There may be an opening for a rearward facing camera lens and for the flash or light built into the phone (if any). While there may be two panels, only one panel or more than two panels can be provided.

To use forward facing imaging functions of a mobile electronic device, such as to take a forward facing photo, in a situation where additional light is needed, the user opens the panels to a deployed position, where they can be held or biased open. The panels have lights, such as LEDs or OLEDs, which are turned on during video and other imaging functions, except that for a still photo the lights may flash, if desired. Note that to the extent OLEDs may not be able to flash, one may combine LEDs with the OLEDs and flash the LEDs. Accordingly, where the video or photo requires more than ambient light and/or at the user's selection, the lights on the panels can provide the desired light.

In accordance with an aspect of an embodiment, the LEDs and/or OLEDs are disposed so that they cast light when the panels are open or closed. That is, the panels are open for a forward facing picture, mirror function, video, or other forward-facing imaging function, and the panels are closed for rearward facing photography or imaging function. In the case of rearward photography or imaging function, the lights on the panels may be used by themselves or may supplement and provide softer light than the usual onboard flash for rearward facing pictures and video. The panels can be made of a base layer such as plastic with either OLEDs covering them or most of them, or a base layer with LEDs on it and a diffusion layer for the LEDS. The diffusion layer may be transparent or translucent light diffusing material such as plastic to provide for an even softer, smoother light. Alternatively, the OLEDs may have incorporated therein a light diffusing layer.

The panels may be connected so that there is a friction fit on the hinge connection and therefore they may be retained in whatever open position is desired.

The structure of the light panels is such that they can be lightweight and easy to use. Lightweight can mean lighter than the device itself, no more than half the device weight, or at least no more than the weight of the device itself.

An embodiment herein can include a mobile electronic device where the case has lighted panels that are lockable or held in a closed position and/or are biased or holdable open, which lighted panels may provide light rearward (for a rear-facing camera lens) when closed and forward (for a front facing, i.e., device screen side, camera lens) when open, and may also provide light for other image functions such as video and mirror functions.

According to another embodiment, a lighting device is disclosed for removable attachment to a mobile device. The lighting device can include a support body, a first panel (or flap) connected to the body and rotatable relative to the body between a closed position and a rotated-out position, and a second panel connected to the body and also rotatable relative to the body between a closed position and a rotated-out position. The first panel includes a first light operatively so that when illuminated the first light shines rearwardly relative to the body when the panel is in the closed position and forwardly when the panel is in the rotated-out position. The second panel includes a second light operatively positioned so that when illuminated the second light shines rearwardly relative to the body when the second panel is in the closed position and forwardly when the second panel is in the rotated-out position. For example, double-sided tape, magnets and the like on a back side of the body can attach the body to a back side of a mobile device.

The present invention also contemplates a photography lighting device for providing a lighting source to a mobile electronic device. The mobile electronic device has a front facing camera and a rearward facing camera. The lighting device includes a case having a forward facing portion and an opposite rearward facing portion, at least part of the forward facing portion being configured to receive at least a portion of the mobile electronic device, a first light source movably connected to the case and movable from a first position to a second position, the first light source being rearward facing in the first position to provide illumination for the rearward facing camera, the first light source being forward facing in the second position to provide illumination for the forward facing camera, a second light source movably connected to the case and movable from a first position to a second position, the second light source being rearward facing in the first position to provide illumination for the rearward facing camera, the second light source being forward facing in the second position to provide illumination for the forward facing camera, a power source for providing power to the first light source and the second light source, and control circuitry for controlling power provided to the first light source and the second light source.

In another embodiment, the present invention also contemplates a photography lighting device for providing a lighting source to a mobile electronic device. The mobile electronic device has a front, a front facing camera, a rear, and a rearward facing camera. The lighting device includes a body having a forward facing portion and an opposite rearward facing portion, the forward facing portion being configured to be removably attached to the rear of the mobile electronic device, a first light source movably connected to the body and movable from a first position to a second position, the first light source being rearward facing in the first position to provide illumination for the rearward facing camera, the first light source being forward facing in the second position to provide illumination for the forward facing camera, a second light source movably connected to the body and movable from a first position to a second position, the second light source being rearward facing in the first position to provide illumination for the rearward facing camera, the second light source being forward facing in the second position to provide illumination for the forward facing camera, a power source for providing power to the first light source and the second light source, and control circuitry for controlling power provided to the first light source and the second light source.

In yet another embodiment, the present invention also contemplates the first light source and the second light source being movably connected to the case by at least one of friction, magnetism, resilient member(s), detent mechanism, springs, and torsion springs. The present invention additionally contemplates the first light source and the second light source including at least one of LED, COB LED, and OLED. The present invention additionally contemplates the case having a top and a bottom, the first light source being movably connected proximate to the top of the case and the second light source being movably connected proximate to the bottom of the case. The present invention additionally contemplates the lighting device including a transceiver to communicate wirelessly with the mobile electronic device. The present invention further contemplates the transceiver utilizing Bluetooth to communicate wirelessly with the mobile electronic device. The present invention additionally contemplates the lighting device including a connection adapter to be electronically coupled to a connection port of the mobile electronic device, thereby facilitating communication between the lighting device and the mobile electronic device. The present invention also contemplates the lighting device including a first flap movably connected to the case and movable from a first position to a second position, the first flap including the first light source, and a second flap movably connected to the case and movable from a first position to a second position, the second flap including the second light source. The present invention further contemplates the first light source and the second light source including a window for transmitting light. The present invention additionally contemplates the windows of the first light source and the second light source being at least one of translucent and a diffuser. The present invention also contemplates at least part of the case being configured to receive the first light source and the second light source when in the first position. The present invention further contemplates the case including at least one finger notch adjacent to the first light source and the second light source when the first light source and the second light source are in the first position to assist in lifting the first light source and the second light source off of the case for movement to the second position. The present invention additionally contemplates the forward facing portion of the body being configured to be removably attached to the rear of the mobile electronic device utilizing at least one of: two-sided tape, a magnet, hook and loop fasteners, a snap mechanism, an elastic strap, and a male member or female member of the body adapted to connect to a corresponding female member or male member of the mobile electronic device.

### BRIEF DESCRIPTION OF THE DRAWINGS

The accompanying drawings, which are included to provide further understanding of the present invention disclosed in the present disclosure and are incorporated in and constitute a part of this specification, illustrate aspects of the present invention and together with the description serve to explain the principles of the present invention. In the drawings:

FIG. 1 illustrates an exploded perspective view of a mobile electronic device and a first embodiment of a lighting device in accordance with the present invention;

FIG. 1A illustrates an exploded perspective view of the first embodiment of the lighting device;

FIG. 2 illustrates a horizontal cross-sectional view of FIG. 1 of the first embodiment of a portion of the mobile electronic device and the lighting device which uses OLEDs;

FIG. 3 illustrates a rear view of the first embodiment of the mobile electronic device and the lighting device with closed panels;

FIG. 3A illustrates a front view of the first embodiment of the mobile electronic device and the lighting device with open panels;

FIG. 4 illustrates a horizontal cross-sectional view of FIG. 1 of the first embodiment of a portion of the mobile electronic device and the lighting device which uses LEDs;

FIG. 5 illustrates a rear view of the first embodiment of the mobile electronic device and the lighting device showing a variation thereof;

FIG. 6 illustrates a cross-sectional view along line 6-6 of FIG. 5;

FIG. 7 illustrates a cross-sectional view along line 7-7 of FIG. 5;

FIG. 8 illustrates a schematic diagram of electronic connections and an application for controlling lights in the lighting device as combined with the mobile electronic device;

FIG. 9 illustrates a rear perspective view of a second embodiment of a lighting device in a first position in accordance with the present invention;

FIG. 10 illustrates a top plan view of the second embodiment of the lighting device in the first position;

FIG. 11 illustrates a bottom plan view of the second embodiment of the lighting device in the first position;

FIG. 12 illustrates a rear elevation view of the second embodiment of the lighting device in the first position;

FIG. 13 illustrates a front elevation view of the second embodiment of the lighting device in the first position;

FIG. 14 illustrates a side elevation view of the second embodiment of the lighting device in the first position;

FIG. 14A illustrates a top plan view of a top panel of the second embodiment of the lighting device;

FIG. 15 illustrates a rear perspective view of the second embodiment of the lighting device in a second position;

FIG. 16 illustrates a rear elevation view of the second embodiment of the lighting device in the second position;

FIG. 17 illustrates a front elevation view of the second embodiment of the lighting device in the second position;

FIG. 18 illustrates a side elevation view of the second embodiment of the lighting device in the second position;

FIG. 18A illustrates a perspective view of a hinge of the second embodiment of the lighting device;

FIG. 18B illustrates a cross-sectional view of the hinge of the second embodiment of the lighting device;

FIG. 19 illustrates a rear perspective view of a third embodiment of a lighting device in a first position in accordance with the present invention;

FIG. 20 illustrates a rear perspective view of the third embodiment of the lighting device in a second position;

FIG. 21 illustrates a front elevation view of the third embodiment of the lighting device in the second position; and

FIG. 22 illustrates an exploded side view of the third embodiment of the lighting device in the first position, an attachment portion, and a mobile device case and/or mobile electronic device.

### DETAILED DESCRIPTION

The detailed description set forth below is intended as a description of various configurations of the present invention and is not intended to represent the only configurations in which the present invention may be practiced. It will be apparent, however, to those of ordinary skill in the art that the present invention is not limited to the specific details set forth herein and may be practiced without these specific details.

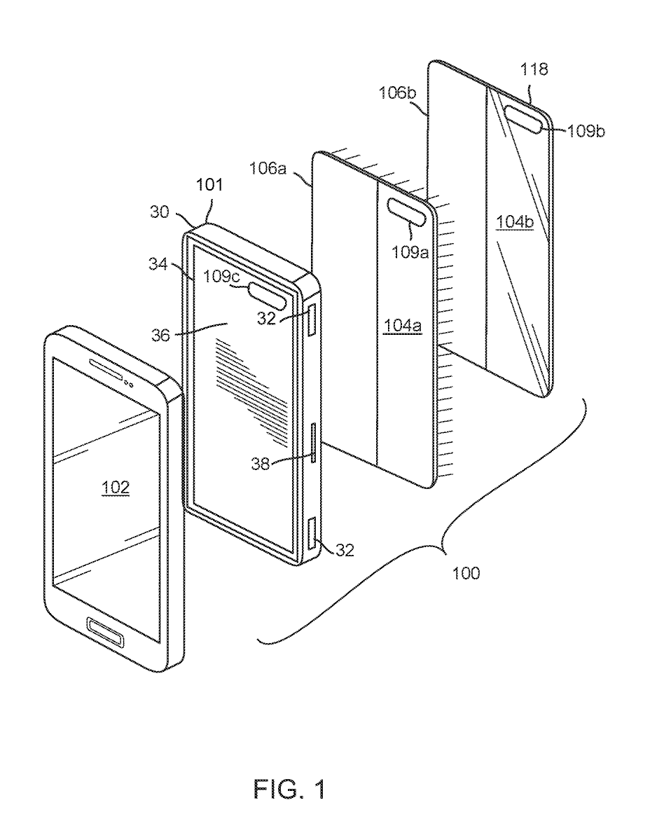

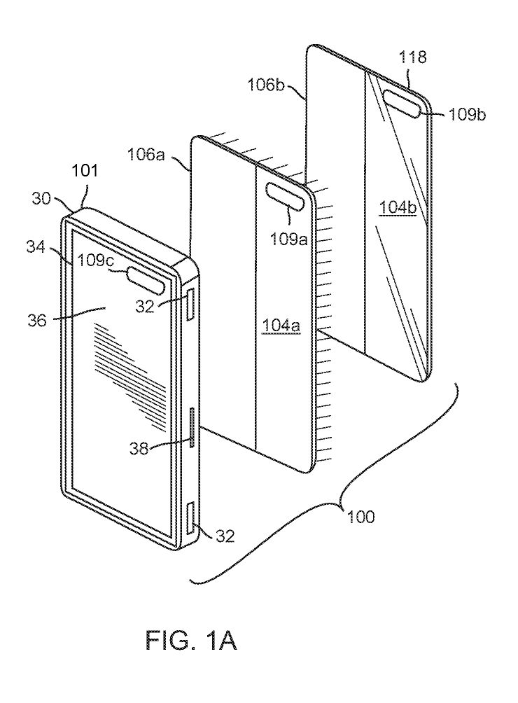

As shown in FIGS. 1-3 and 3A, there is a lighting device 100 and an electronic mobile device 102 such as a mobile phone or a tablet computer, laptop computer or other mobile electronic device, such as an iPad®, iPhone®, Motorola Droid®, and/or Samsung Galaxy®, and/or any other mobile electronic device.

Lighting device 100 may include a mobile device case 101, which may be configured to receive at least a portion of mobile device 102. For example, mobile device case 101 may have a body 30 or housing that surrounds the edges of mobile device 102. Body 30 may extend around mobile device 102 to protect mobile device 102 from impact and to help provide a good surface to grip. Body 30 may protrude slightly at edges 34 past the front face of mobile device 102 (that the case is dimensioned to fit) to further protect mobile device 102 from impact. Mobile device case 101 may surround or cover only the back and sides of mobile device 102. Body 30 of mobile device case 101 may be made using an injection molded silicone or body 30 of mobile device case 101 may be a hard plastic case. In some versions, body 30 of mobile device case 101 may be fabric or other material, or a semi-rigid material such as a gel case. Such a case holds its basic shape yet has some flexibility enabling insertion and removal of mobile device 102.

Mobile device case 101 can at least slightly overlap the front edges of mobile device's 102 front face to help hold mobile device 102 by interference fit and/or friction fit. Alternatively, there may be a panel to cover the front of mobile device 102 with openings for the screen and any buttons, and which may flip up or down. Also, body 30 may have several openings for buttons and connectors, and a rear stand, as desired and depending on the specific mobile device (such as brand and model) that mobile device case 101 is adapted for.

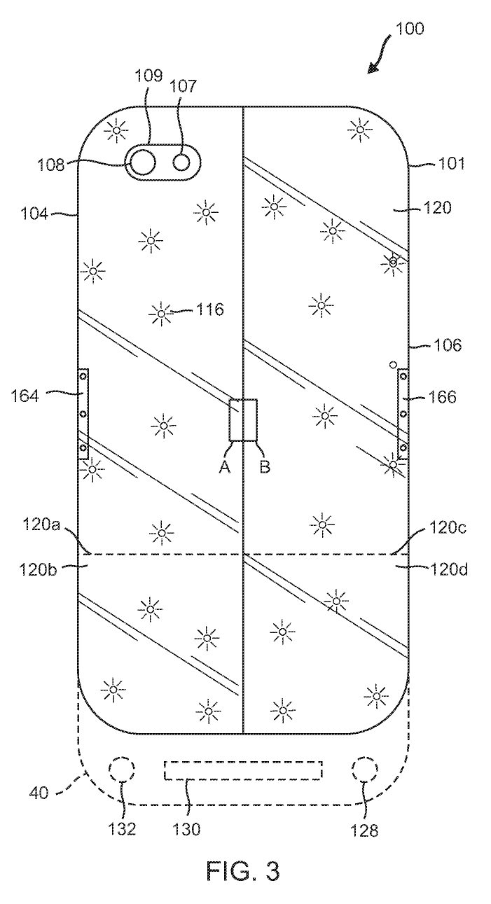

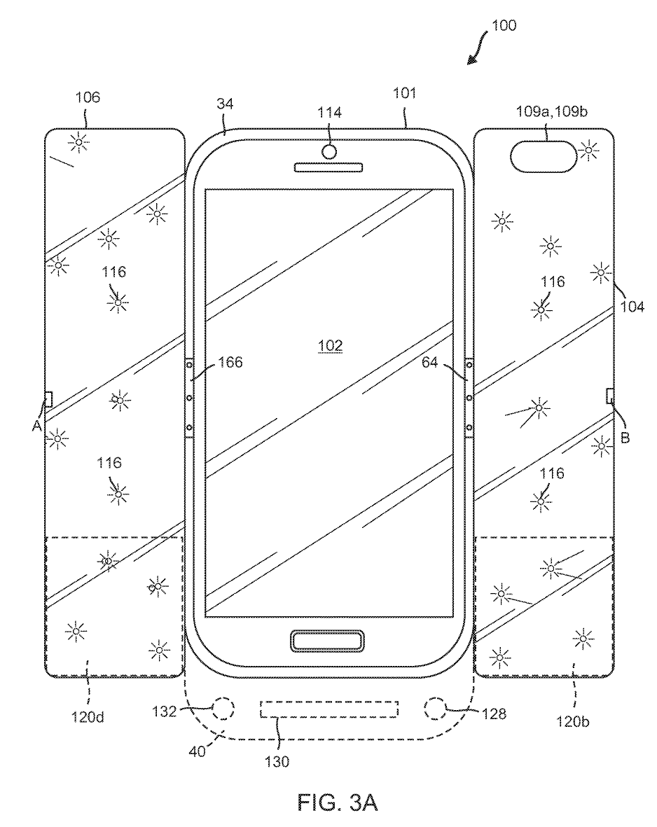

Lighting device 100 may include light panels (or flaps) 104, 106, shown open in FIG. 3A (front view) and closed in FIGS. 1 and 3 (rear view) that may be connected to mobile device case 101. There is a rear-facing onboard light 107 typically formed by one LED or two or more clustered LEDs and a rear-facing camera lens 108. Mobile device case 101 has an opening 109 for rear-facing camera lens 108 and onboard light 107.

Light panels 104, 106 are shown in FIG. 3A open to 180 degrees or substantially that amount, although other comparable amounts may be possible. Light panels 104, 106 are shown illuminated and may be used in conjunction with a front-facing camera lens 114 on the front of mobile device 102.

Each light panel 104, 106 can have a light producing layer 104a, 106a having LEDs 116 or one or more OLEDs 143 thereon and in the case of LEDs 116, each light panel 104, 106 also may have a light diffusing layer 104b, 106b. Each light producing layer 104a, 106a has multiple LEDs 116 or has or is formed of an OLED 143 (either completely or substantially completely, or at least a portion). When using LEDs 116, each light producing layer 104a, 106a can be covered and protected by light diffusing layer 104b, 106b, together referred to as a diffusion covering 118, which may be formed by transparent or translucent, diffused, injection molded silicon. When using OLEDs 143 having their own diffusion, covering 118 (light diffusing layers 104b, 106b) is unnecessary and often not used or formed as a clear plastic for extra protection.

Covering 118 changes the light that comes from LEDs 116 from individual, small, specular, unflattering light to larger, softer more flattering (diffused) light. A reflective material may be along the base of each light panel 104, 106.

For simplicity and better understanding, LEDs 116 are shown in FIGS. 3 and 3A without a diffusion covering. The number and light output and color rendering index (CRI) of LEDs 116 and their exact number and positions will vary based on a number of factors, such as what specific mobile device 102 mobile device case 101 is adapted for holding. When closed, covering 118 will also protect the rear of mobile device 102.

Instead of LEDs 116, OLEDs 143 can be used. In such a case, the OLEDs 143 and thus the case may be made very flexible as well as clear. Other light sources may be suitable for the intended purpose and understood by one of ordinary skill in the art. If desired, the edges of light panels 104, 106 may have a relatively rigid material to form a frame.

Light panels 104, 106 are rotatably mounted to a portion of mobile device case 101, so as to be rotatable between the closed position of FIG. 3 and the open position of FIG. 3A.

In FIG. 3, mobile device case 101 is shown with light panels 104, 106 closed and illuminated for use with rear-facing camera lens 108. When camera 108 is not in use, light panels 104, 106 may be off. Alternatively, light panels 104, 106 can be in the open position and be clear or translucent on both sides. Therefore, in the open position of FIG. 3A, lights would shine forwards and backwards with respect to the front of mobile device 102. However, a reflective material or coating can be provided on the back side of light panels 104, 106 when facing forward which corresponds to the rear or inside of light panels 104, 106 in FIG. 3. The light will at least shine to the rear when light panels 104, 106 are closed (FIG. 3) and the lights are on, and to the front when the panels are open (FIG. 3A).

Body 30 may include button or port openings 32 (FIG. 1), corresponding to the location of the buttons and/or ports of the selected device brand and model, so placement will vary accordingly.

Having a diffuser between the light source (in this case LEDs 116 or OLEDs 143) and the subject is an important factor when creating soft, flattering light, especially when using a small or point light source like LED 116. The diffuser spreads out and scatters the light, thus softening the light and creating a broader more uniform light over an area. Such a broad, soft, diffused light helps minimize shadows by enveloping the subject, and in turn reduces the appearance of skin blemishes and wrinkles.

As shown in FIGS. 3 and 3A, mobile device case 101 may have a lower section 40 where there may be useful buttons and parts, such as an override button 128. Such a button may allow the user to adjust the amount of light coming from LEDs 116 or OLEDs 143. Override button 128 may have various functions, such as off, low, medium, high and off again. Override button 128 (or another button) thus may be used for on/off in addition to brightness adjustment.

Diffused, soft, adjustable, warm light ready at all times within lighting device 100 will improve the resulting images for the various photography functions regardless of the existing lighting conditions and will also allow the user to see themselves in a flattering, controlled light when video chatting or using mobile device 102 as a mirror.

Lighting device 100 may include a battery 130 that may be in mobile device case 101. Moreover, battery 130 may be used as a supplemental power supply for mobile device 102 (labeled in FIG. 3A) when its battery runs out. For powering battery 130, mobile device case 101 may plug into mobile device 102 and power via mobile device's 102 battery 134 or mobile device case 101 may charge via a wireless charging system, or its own wired charging system. Alternatively, mobile device case 101 need not have its own power. Mobile device case 101 may have a wire to plug into an outlet from mobile device 102 to use mobile device's 102 power.

Mobile device case 101 may include an on/off button 132 to activate battery 130 to power mobile device (phone) battery 134. When in the off position, battery 130 will only be used to power LEDs 116 or OLEDs 143 in lighting device 100.

With reference to FIG. 1, an exploded perspective view, body 30 protects the sides, top, bottom, and the edges of mobile device 102 as well as the rear of mobile device 102 and can be made of injection molded silicon, or other suitable materials or a composite of materials as well.

Body 30 has a cavity 36 which houses mobile device 102. Dimensions of cavity 36 will vary based on manufacturer and model type of mobile device 102 (e.g., brand and model of phone or tablet), with a friction or snap fit.

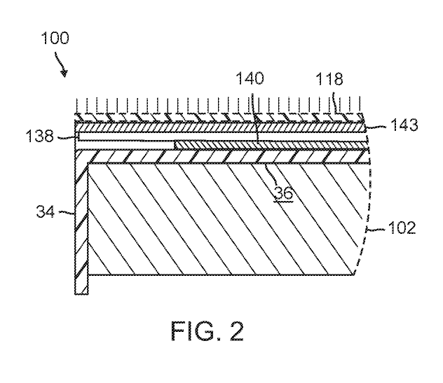

FIG. 2 is a horizontal cross-sectional view of a portion of lighting device 100 and mobile device 102. Rear-facing OLED 143 and optional rear protective light diffusing layer 104b may be seen. Light diffusing layer 104b can be made of transparent, diffused injection molded silicon, or other suitable materials. In this embodiment, LEDs 116 are replaced by OLED 143 sheet(s).

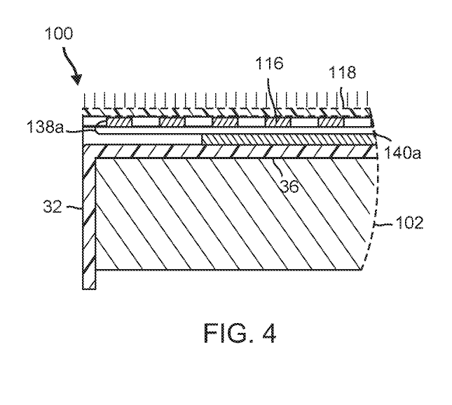

Lighting device 100 also may include circuitry 140 for controlling power provided to light panels 104, 106. Mobile device case 101 may house circuitry 140 and other electronic components to supply power to OLED 143 (or LEDs 116) along a lead or leads 138. In FIG. 2, mobile device case 101 is similar to that of FIG. 4, but uses OLEDs 143 as the light source instead of LEDs 116. Where mobile device case 101 has lower section 40 containing a battery, on/off switch 132 and/or override switch 128, circuitry 140 may be located in lower section 40. In that situation, lead wires 138 (for each light panel 104, 106) may extend through the sides of mobile device case 101 to lower section 40. Circuitry 140 may include an LED or OLED driver circuit, and any other appropriate circuit elements.

Circuitry 140 to the electronic components to supply power to OLEDs 143 may alternatively be housed elsewhere within edges 34 of mobile device case 101 that form edges of body 30. In FIG. 4, which is the LED embodiment, circuitry for LED 116 is denoted 140a and the lead wire is denoted 138a.

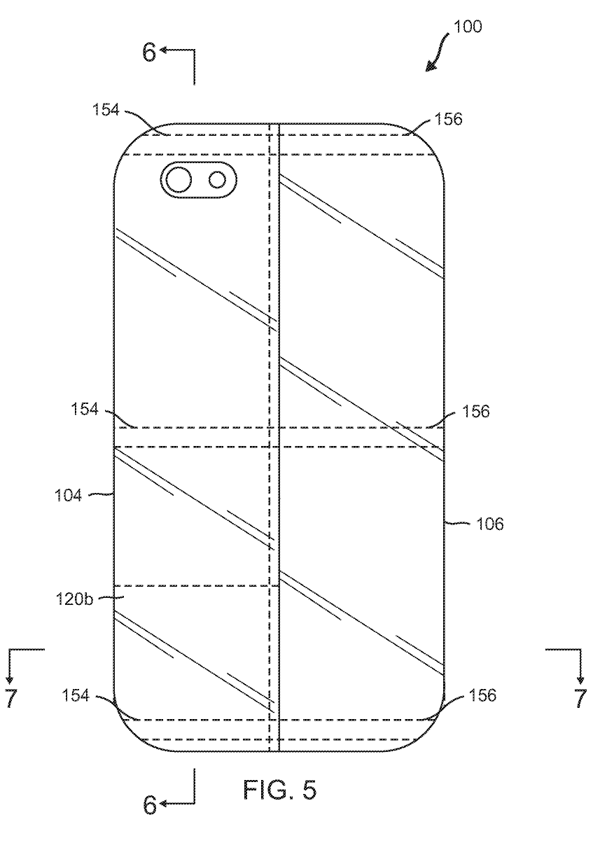

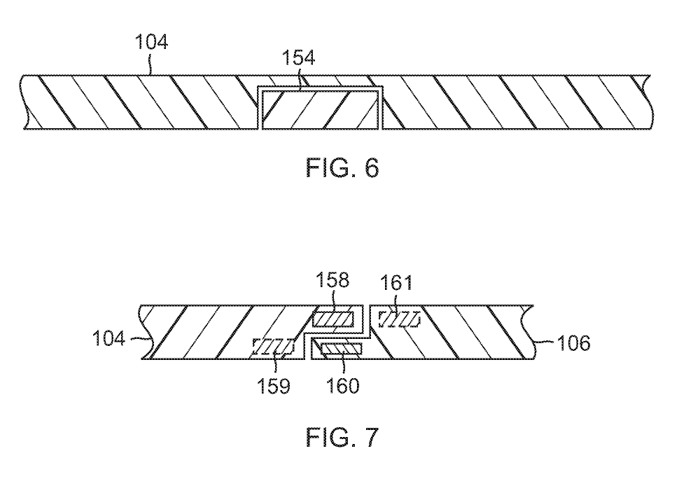

With reference to FIGS. 5-7, various details and examples which bias or hold light panels 104, 106 open, and the mechanisms to hold them or bias them closed are explained.

As shown in FIG. 5, there may be one or more bands 154 under tension that connect light panel 104 at their right ends with body 30 at their left ends, thereby biasing light panels 104, 106 open. There may be a detent mechanism 38 (as shown in FIG. 1 along the outer side edges of body 30) to grip and hold the edges of light panels 104, 106 when open to 180 degrees or about 180 degrees. To overcome the detent, one merely pulls or pushes on light panels 104, 106. To hold light panels 104, 106 closed, there may be a magnetic strip and a metal strip or two magnetic strips 158, 160 along the inner edges of the panels or lighted panels 104, 106, which mate and/or nest or overlap when closed (see FIG. 7). There may be additional magnetic strips and/or metal strips 159, 161 to assist in holding light panels 104, 106 closed.

Rather than bias light panels 104, 106 with a band, such as a rubber band, a torsion spring 164, 166 or other mechanism (FIGS. 3 and 3A) can be used that is suitable for the intended purpose and understood by one of ordinary skill in the art. Springs 164, 166 may have one end attached to panel 104, 106 and one end attached to body 30. Springs 164, 166 could also be set to bias light panels 104, 106 closed, if preferred. In either case, detent mechanism 38 may be used to hold light panels 104, 106 open.

Further, torsion springs 164, 166 may simply be hinges, and if so, then hinges with sufficient friction such that light panels 104, 106 may stay open (or closed) at any desired angle. Then the user may simply close them. In this case, the magnetic or other locking mechanism to keep light panels 104, 106 normally closed may be unnecessary and thus would be optional.

A further alternative is to omit the biasing mechanism, and to use detent mechanism 38 to hold light panels 104, 106 open, and magnetic strip(s) 158, 160 to hold light panels 104, 106 closed. Instead of magnetism to hold light panels 104, 106 closed, a friction fit, detents on body 30, a snap and/or other mechanical mechanisms may be used.

Detent mechanism 38 may be placed on the back of body 30 at the edges, in which case the edges may extend out from mobile device 102 further than would otherwise be needed, and light panels 104, 106 may rotate about an axis inward from the edges of body 30. That way, a mating protrusion or protrusions (or recess or recesses) may be fixed or formed on the outer face of light panels 104, 106 near the axis of rotation the same distance from the axis as detent mechanism 38 is, so that they mate when light panels 104, 106 are open, thus holding light panels 104, 106 open. This detent and protrusion or recess mechanism may be similar to that in U.S. Pat. No. 6,575,323 or U.S. Pat. No. 5,588,546, both incorporated by reference herein.

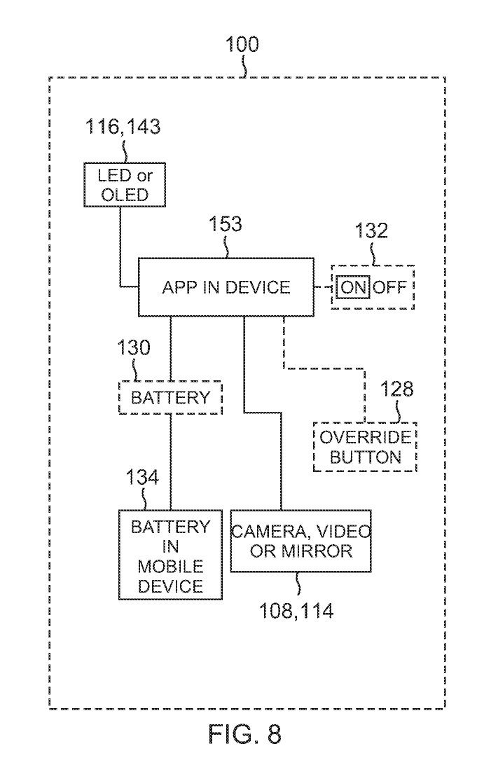

FIG. 8 illustrates an electrical diagram of lighting device 100 in accordance with an embodiment herein. The electrical diagram shows mobile device battery 134 and battery 130 inside mobile device case 101, built-in cameras 108, 114, override button 128, the in-phone (or in-device) application 153 (e.g., mobile “App”), LEDs or OLED light panels 104, 106 described and illustrated herein.

Lighting device 100 adds soft, warm, diffused, i.e., flattering light when using the front facing, or rear facing camera on a phone device, tablet, laptop or any other suitable mobile electronic device. Lighting device 100 provides multiple, several or many LEDs 116 on each light panel 104, 106, or one or more OLEDs 143 per light panel 104, 106. Instead of using or only using mobile device's 102 onboard light source (i.e., one LED 116 or a cluster of adjacent LEDs 116) that provide concentrated, harsh light, the user may achieve light that is diffused or spread out, and soft.

Such warm light may be in a temperature range of 2500 to 3300 degrees Kelvin or at least no more than 4000 degrees Kelvin (although other ranges may be used).

Diffused light (nonspecular light) is light spread out at many angles by the diffusing element (e.g., OLEDs 143 with essentially built-in diffusion or LEDs 116 with a diffusion element). The creation of diffused light, as opposed to the typical specular light source on a mobile device, is much more flattering to the subject. Specular light provided by one or two LEDs 116 without diffusion or with very limited diffusion, i.e., most of the light is not reflected or dispersed, as light emanates from the light source to the subject, is not flattering to the subject and results in bright spots, red eye, and potentially other issues. However, diffused light, where most of the light coming from the light source is deflected or scattered at multiple angles, is much more flattering to the subject. The following definitions of “diffused light” help provide an understanding of the beneficial effects of the creation of soft, diffused, warm light generated in embodiments herein.

1) Diffused light is a soft light with neither the intensity nor the glare of direct light. Diffused light is scattered and comes from all directions. Thus, diffused light seems to wrap around objects. Diffused light also is softer and does not cast harsh shadows.

2) Diffused light is softer than direct light, with shadows that are less sharply-defined (lower contrast). Light that has been softened by cloud cover or any other translucent element. Light that is scattered and spread out as opposed to specular light.

3) Diffused light comes from a light source that is so large relative to the subject that the light source illuminates from several directions. On a hazy or overcast day, illumination comes from the entire dome of the sky, not from the brighter, but smaller, sun.

Strictly speaking, given the size of a typical mobile phone, the size of light panels 104, 106 may not be large enough to produce completely diffused light with respect to a larger subject. However, the light produced from a device in accordance with the present disclosure is significantly more diffused than the light produced by the typical one or two LEDs or small cluster of LEDs on a mobile device.

To provide soft light, i.e., significantly softer than the typical one or two LEDs 116 which are essentially a point source (specular) on the typical mobile device, LEDs 116 (or OLED 143) are spread out across an area that is roughly equal to the area of one large face of mobile device 102, particularly when mobile device 102 is a mobile phone. Most mobile phone sizes are within about two square inches (2 in²) to about sixteen square inches (16 in²) or even larger for larger devices.

The larger the area that the light emanates from, generally the softer the light as it would tend to wrap more around the subject the more as the area increases. Typically, the light from a smartphone flash will be well less than an area of one half inch squared, and will therefore be very harsh. Accordingly, the area of the light from light panels 104, 106 can be at least about half the area of the phone's main face, or about seventy-five percent, and even at least about (within ten percent of) the area of the phone's main face (screen plus the rest of the front surface of the phone or device), and generally will not be larger than the area of mobile device's 102 main face, although light panels 104, 106 that are collectively larger than mobile device's 102 main face can be constructed.

As noted above, light panels 104, 106 may be lit continuously during use, rather than just flash. To control the amount of light, override button 128 may be used. Control is especially helpful when using forward-facing camera lens 114 since this is usually for a selfie or other close range photography or image function.

Another way to adjust the amount of light from light panels 104, 106 may be by utilizing an App. Apps are downloaded to mobile electronic devices, usually from an App store such as iTunes®, Android®, Google® or Windows®. Thus, lighting device 100 may function along with an App. Light panels 104, 106 may also have their light adjusted when using the rear-facing camera lens 108 via buttons and/or via an App. The App may be a modified version of the same App(s) that perform the image functions for mobile device 102, or the App may be a separate App.

The user may use override-switch 128 to ON or OFF 132, or use override-switch 128 to change the amount of light coming from lighting device 100 for image functions. In the ON position, the LEDs 116 or OLED(s) 143 on light panels 104, 106 are on. In the OFF position, the LEDs 116 or OLED(s) 143 are not illuminated and are prevented from turning on. When in the ON position, the user can reduce or increase the amount of light emanating from mobile device case 101. The user can select ON or OFF at any time to control LEDs 116 or OLED(s) 143.

Lighting device 100 may also have a space for a stand when a stand is part of mobile device 102, and/or mobile device case 101 may be made with a stand for hands-free use.

On versions of lighting device 100 that include battery 130, the user can also set ON/OFF button 132 (e.g., battery switch) to ON to charge mobile device battery 134, or OFF to prevent mobile device battery 134 from charging from case's battery 130.

Lighting device 100 allows the user to control how much light comes from light panels 104, 106, allowing for sharper, more flattering pictures and video and allowing consumers to use their mobile device cameras in low light or no light. Lighting device 100 also allows for use of diffused light. In fact, instead of forming diffusion covering 118 with an aperture 109b which aligns with aperture 109a in light producing layer 104a for aligning with aperture 109c in body 30 (to form opening 109), the part of aperture 109b that aligns with mobile device's 102 onboard light 107 (e.g., LED(s)) may also be formed as part of diffusion covering 118, to further soften the light. Alternatively, by utilizing App 153 (which may be mobile device's 102 camera App), onboard light 107 may be turned off (no flash/no light mode) to avoid its harsh lighting when using light panels 104, 106.

In another variation, as shown in FIG. 3, one or both of light panels 104, 106 may be formed without a lower portion 120b and/or 120d, which is the portion below dashed lines 120a, 120c. Particularly in the situation where light panels 104, 106 are open as in FIG. 3A, having no lower portion 120b and/or 120d of light panels 104, 106 would enable a user to hold mobile device 102 from mobile device 102 and/or case body 30, such as pinching mobile device 102 and/or case body 30 between finger(s) and thumb, for more securely holding mobile device 102.

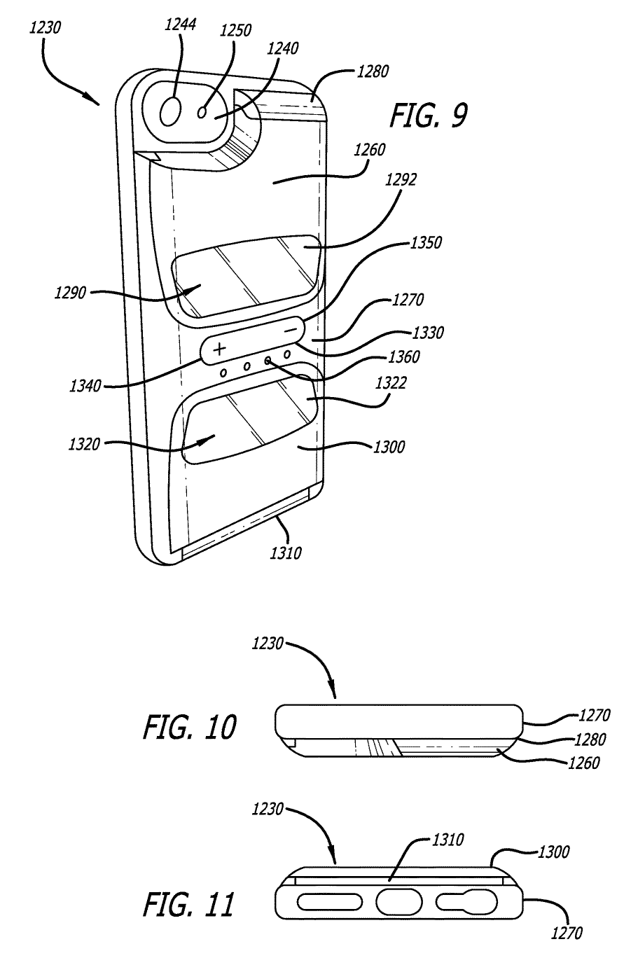

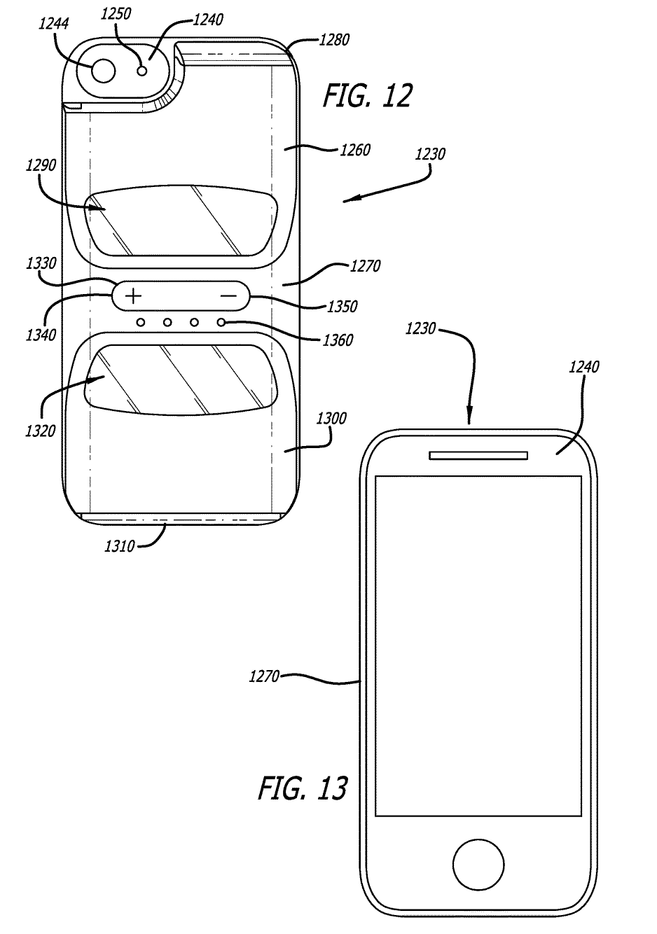

FIGS. 9-14A illustrate a second embodiment of a lighting device 1230 in a first position (e.g., closed position) in accordance with the present invention. A mobile electronic device 1240 (e.g., a mobile phone, such as an iPad®, iPhone®, Motorola Droid®, and Samsung Galaxy®, a tablet computer, laptop computer, or any other mobile electronic device) is illustrated as being received within lighting device 1230. Mobile electronic device 1240 also is shown having a camera 1244 and a flash 1250. The position of camera 1244 and flash 1250 on lighting device 1230 may vary depending on the make and model of mobile electronic device 1240.

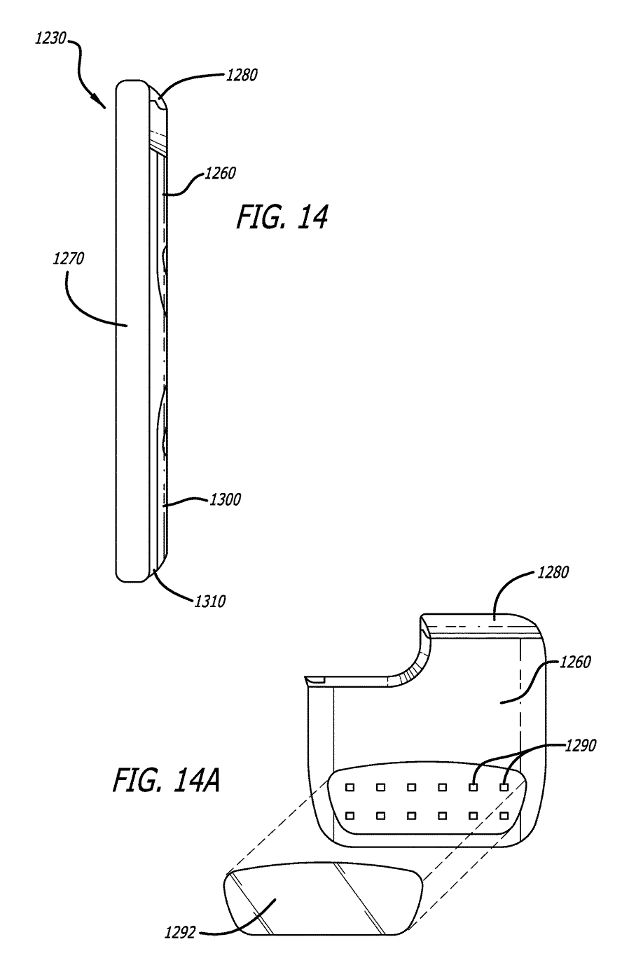

Lighting device 1230 may include a body 1270 and a top panel 1260 that is connected to body 1270 by an elongate hinge 1280. Top panel 1260 of lighting device 1230 may include a light source 1290 that is protectively enclosed under a window or a cover 1292 as described above. Suitable lights for light source 1290 are discussed earlier in this disclosure, and examples thereof are LEDs, OLEDs, chip-on-board (COB) LEDs, and other lights suitable for the intended purpose and understood by one of ordinary skill in the art, which are shown in FIG. 14A without window or cover 1292. Light source 1290 may be in a temperature range of 2500 to 3300 degrees Kelvin or at least no more than 4000 degrees Kelvin (although other ranges may be used). Cover 1292 for light source 1290 may also have light distribution functions as discussed earlier.

Similarly, lighting device 1230 may include a bottom panel 1300 that is connected to body 1270 by an elongate hinge 1310. Top panel 1260 and bottom panel 1300 may be connected to body 1270 by any connection mechanism suitable for the intended purpose and understood by one of ordinary skill in the art. Bottom panel 1300 of lighting device 1230 also may include a light source 1320 that is protectively enclosed under a window or a cover 1322 as described above.

Light sources 1290, 1320 of top and bottom panels 1260, 1300 provide: 1) a wider area of illumination that offers a larger area of coverage; 2) a reduction in the formation of shadows from imperfections of a person's face, which reduces the appearance of blemishes, wrinkles, and other imperfections; 3) less stress on the user's eyes when the lights are positioned above and below the case, this means that the user is not looking directly into the lights; and 4) flaps that open independently from one another that allows the user to be able to choose opening only one flap at a time for additional directional light or reduced intensity of light. While lighting device 1230 may include top and bottom panels 1260, 1300, lighting device 1230 may include only one panel or more than two panels with each panel including a light source.

It is contemplated that light sources 1290, 1320 may extend beyond the footprint of mobile electronic device 1240 when lighting device 1230 is in the second position to provide the added benefits described above.

Mounted to body 1270 between top and bottom panels 1260, 1300 is a toggle-type switch 1330 for controlling the brightness of light sources 1290, 1320 of top and bottom panels 1260, 1300. Pushing down on a left end 1340 of switch 1330 incrementally increases the brightness of light sources 1290, 1320 of top and bottom panels 1260, 1300. Similarly, pushing down on a right end 1350 of switch 1330 incrementally dims light sources 1290, 1320 of top and bottom panels 1260, 1300. Alternatively, switch 1330 may incrementally increase the brightness of light sources 1290, 1320 by pushing down on right end 1350 of switch 1130 and incrementally dim or decrease the brightness of light sources 1290, 1320 by pushing down on left end 1340 of switch 1330.

The battery or batteries for powering light sources 1290, 1320 can be mounted or integrated into top and/or bottom panels 1260, 1300 or body 1270. The batteries also may be associated with control circuitry of lighting device 1230. The control circuitry of lighting device 1230 may be integrated into body 1270 of lighting device 1230 and control the amount of power delivered to light sources 1290, 1320. A plurality of battery level indicator lights 1360, which are depicted adjacent to switch 1330 but may be positioned elsewhere along body 1270 of lighting device 1230, informs the user of the amount of charge left in the battery.

Lighting device 1230 (or module) can work independently of mobile electronic device 1240, and the batteries and light sources 1290, 1320 may run independently of mobile electronic device 1240. Lighting device 1230 does not need to electronically connect to mobile electronic device 1240 because light sources 1290, 1320 may be continuous light sources and thus do not require syncing with mobile electronic device 1240 when taking a picture or video (e.g., flash coordination). However, it is within the scope of the present disclosure to have lighting device 1230 connect to either work with an App or charge mobile electronic device 1240 by being electronically coupled by at least a physical or wireless connection. This connection can be made with Bluetooth, induction charging, Lightning connector, mini-USB, a short USB to light insight port cable, a short USB to USB cable, or any cables or connectors suitable for the intended purpose and understood by one of ordinary skill in the art.

It is also within the scope of the disclosure for light sources 1290, 1320 to be powered by the batteries of mobile electronic device 1240 to which lighting device 1230 is attached and to provide an electrical wire or other connection between body 1270 and mobile electronic device 1240.

When top and bottom panels 1260, 1300 of lighting device 1230 are in the first position (e.g., closed position), light sources 1290, 1320 of top and bottom panels 1260, 1300 may illuminate light rearward relative to mobile electronic device 1240 to provide illumination for the rearward facing camera 1244.

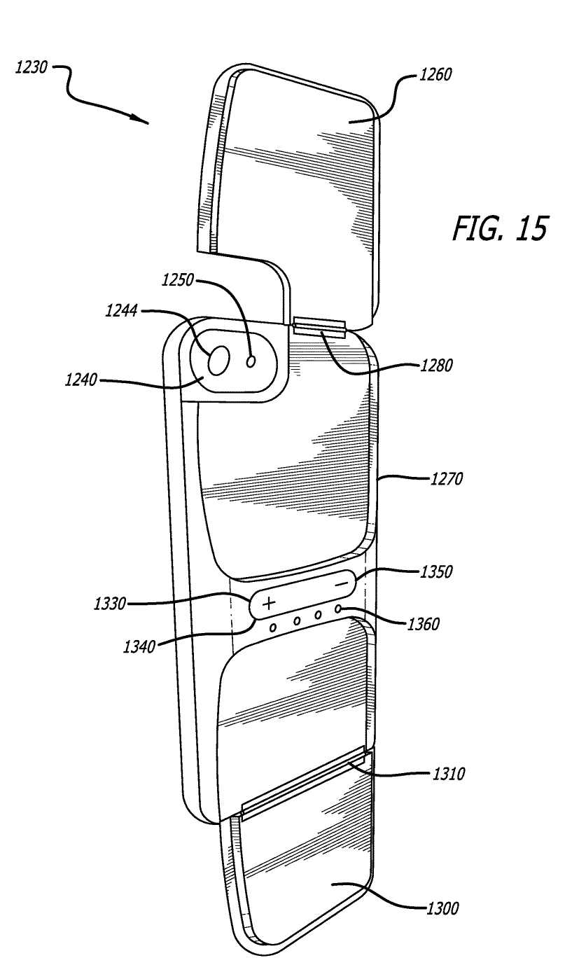

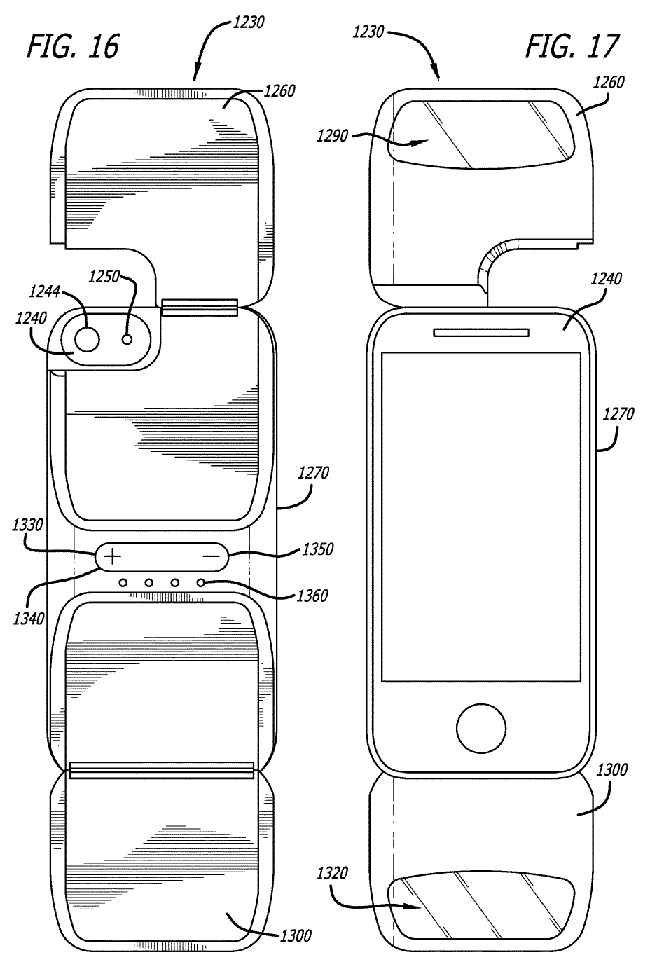

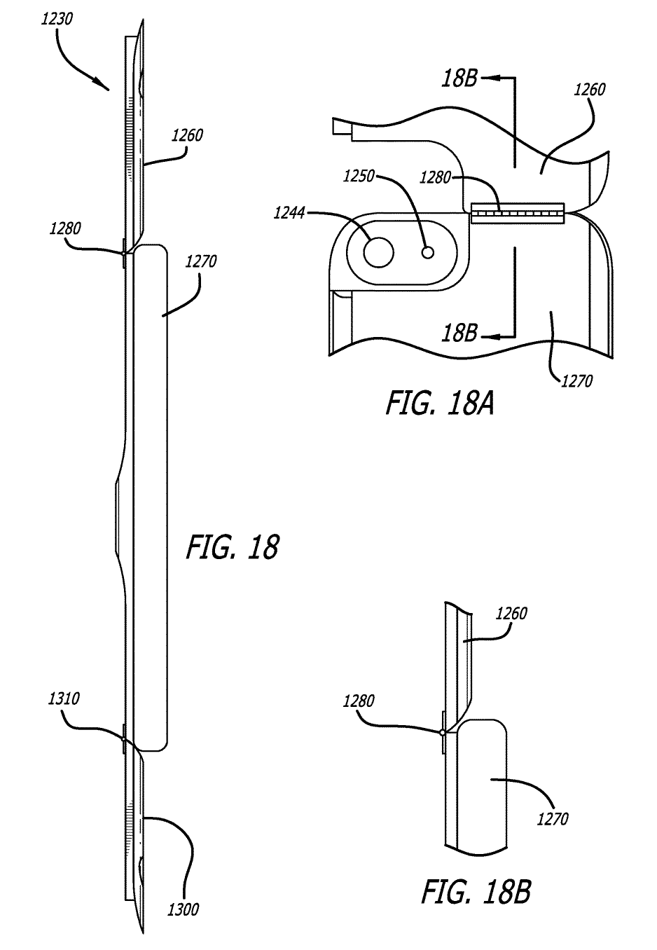

FIGS. 15-18B illustrate the second embodiment of lighting device 1230 in a second position (e.g., open position) in accordance with the present invention. Top and bottom panels 1260, 1300 are in the second position and rotated about hinges 1280, 1310 to be in an open or rotated-out position. An example of elongate hinge 1280 is shown in FIGS. 18A and 18B. In the second position, light sources 1290, 1320 of top and bottom panels 1260, 1300 may illuminate light forward relative to forward facing camera of mobile electronic device 1240 to provide illumination for the forward facing camera.

Hinges 1280, 1310 may be provided with protective snap-fit hinge covers. Hinges 1280, 1310 also may allow lighting device 1230 to pivot on multiple axes. For example, when in the second position, top and bottom panels 1260, 1300 of lighting device 1230 may further pivot on hinges 1280, 1310 so that light sources 1290, 1320 may illuminate light rearward relative to mobile electronic device 1240 to provide illumination for the rearward facing camera 1244.

Alternatively, instead of being connected to body 1270 by hinge 1280, top and bottom panels 1260, 1300 of lighting device 1230 also may be configured to extend from a first position to a second position by utilizing a sliding mechanism. The sliding mechanism may include slide rods, slider plates, sliding channels, and any other sliding parts for the intended purpose. For example, top panel 1260 may slide upward to the second position and provide illumination for the rearward facing camera. Also, bottom panel 1300 may slide downward to the second position and provide illumination for the rearward facing camera. Light sources 1290, 1320 also may pivot about a hinge or swivel when top and bottom panels 1260, 1300 are in the second position, thereby providing illumination for the forward facing camera.

Lighting device 1230 also may include a light meter that measures the amount of detected light. In turn, the control circuitry of lighting device 1230 may adjust the amount of power delivered to light sources 1290, 1320 accordingly.

Lighting device 1230 may include at least one finger notch adjacent to top and bottom panels 1260, 1300. When top and bottom panels 1260, 1300 are in the first position, the finger notch may assist in lifting top and bottom panels 1260, 1300 off of lighting device 1230 for movement to the second position. Lighting device 1230 also may include a release mechanism (e.g., a button along with a spring or any mechanism suitable for the intended purpose) that retains top and bottom panels 1260, 1300 in the first position. When the release mechanism is depressed, top and bottom panels 1260, 1300 move from the first position to the second position.

There are times when it may be desirable to provide a lighting device as a separate modular unit and not affixed to or integral with a mobile electronic device. This embodiment of a lighting device may be removed when not needed and may be attached when needed. The lighting device may be attached to a variety of similar or identical mobile devices. This can have cost saving and convenience advantages. Also, where there are lighting devices or lighting environments having different lighting characteristics, a user can swap one for another as desired.

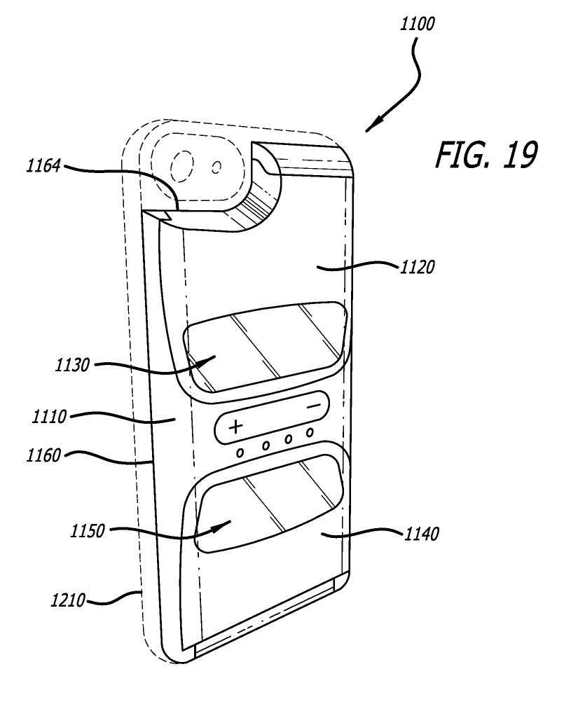

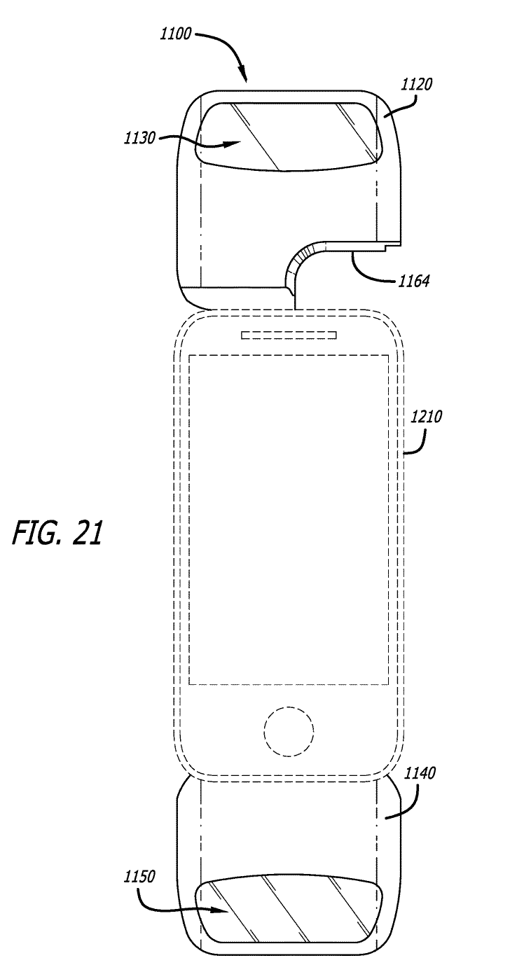

FIGS. 19-22 illustrate a third embodiment of a lighting device 1100 of the present invention. Lighting device 100 may include: a body 1110, a top panel (or flap) 1120 having a light source 1130, a bottom panel (or flap) 1140 having a light source 1150, and double-sided tape or magnet attachment 1160 on a back side of body 1110. Attachment 1160 allows lighting device 1100 to be releasably attached to a back side of a mobile electronic device 1210 or to a mobile device case and thereby into an operative position. The configuration of body 1110 includes in a top corner thereof a camera area cutout 1164.

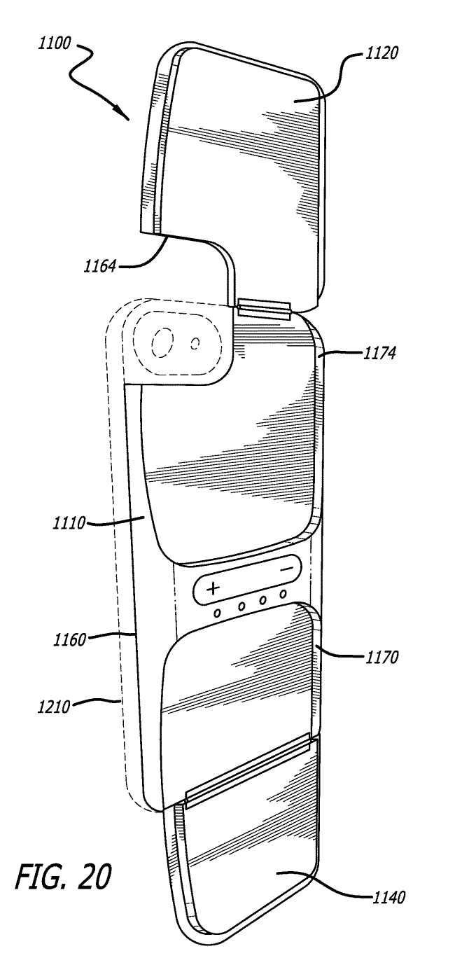

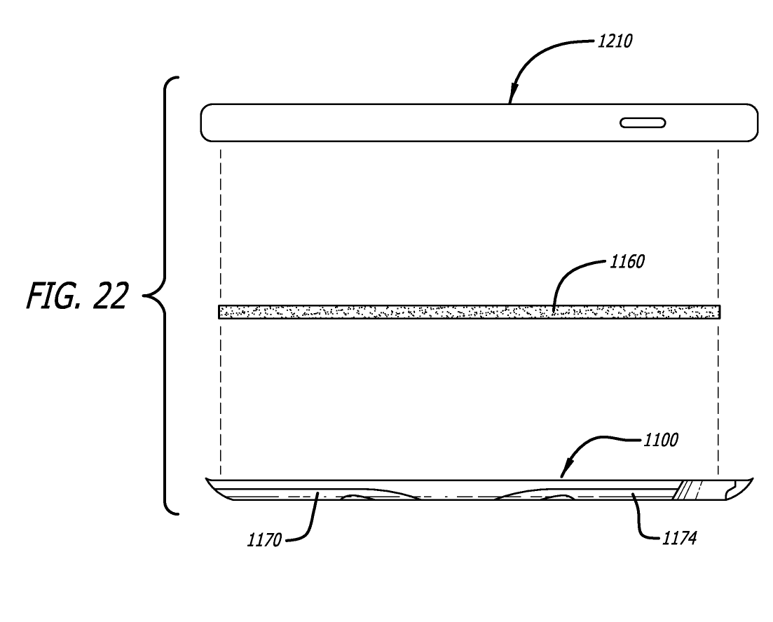

In FIGS. 19 and 22, top and bottom panels 1120, 1140 are shown in a first position (e.g., closed position). In the first position, top and bottom panels 1120, 1140 can be positioned in conforming recesses 1170, 1174 (as illustrated in FIGS. 20 and 22) on a back surface of body 1110. Conforming recesses 1170, 1174 may include side grooves that allow a user to access conforming recesses 1170, 1174. The user may insert his/her finger into the grooves of conforming recesses 1170, 1174 to easily access either side of top and bottom panels 1120, 1140. Top and bottom panels 1120, 1140 can then be rotated out to a second position (e.g., open position) about their respective hinges to “open” or “rotated-out” positions.

Body 1110 may have length, width and thickness measurements of 4.5 inches to 6.5 inches, 2.75 inches to 3.75 inches, and 1/16th of an inch to 0.5 inch, respectively. Top and bottom panels 1120, 1140 may have length, width and thickness measurements of 2 to 4 inches, 2.5 to 3.75 inches, and 1/16th to 0.5 inch, respectively. Also, light sources 1130, 1150 may have a length of 0.25 to two inches and a width of one to 3.75 inches.

FIG. 22 illustrates an exploded side view of lighting device 1100 with attachment 1160, which is shown in a separated position for illustrative purposes. Moreover, attachment 1160 which releasably attaches the body of lighting device 1100 to a back side of mobile electronic device 1210 or its case.

There are a number of methods and devices for removably attaching lighting device 1100 to mobile electronic device 1210. Referring to FIGS. 19 and 22, double-sided tape or magnet attachment 1160 can be used on body 1110. Other methods and devices can include elastic bands, snap-on arrangements, hook-and-loop (Velcro) strips, male and female latch members, and other methods and devices for attachment suitable for the intended purpose and understood by one of ordinary skill in the art. Some methods and devices require special structure on mobile devices and some do not. Another type of attachment can be a flexible perimeter rim that snaps onto outer edges of mobile electronic device 1210, e.g., phone. Lighting device 1100 can include an adjustability feature so lighting device 1100 can fit different sizes of phones.

Spatially relative terms, such as “inner,” “outer,” “beneath,” “below,” “lower,” “upper,” “above,” “forward,” “rearward,” “right,” “left,” “top,” and “bottom,” may be used herein for ease of description to describe one element's or feature's relationship to another, but the disclosure is intended to encompass different orientations of the device (e.g. the mobile device or the lighting device) in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated ninety degrees or at other orientations) and the spatially relative descriptors used herein interpreted accordingly.

Although the invention has been described using specific terms, devices, and/or methods, such description is for illustrative purposes of the preferred embodiment(s) only. Changes may be made by those of ordinary skill in the art without departing from the scope of the present invention, which is set forth in the following claims. For example, instead of OLEDs or LEDs, another lighting or electronic lighting source may be used that is suitable for the intended purpose and understood by one of ordinary skill in the art.

In addition, it should be understood that aspects of the embodiments herein generally may be interchanged in whole or in part. The disclosure further includes the individual parts and/or combinations/subassemblies, methods of making the parts, methods of assembling the parts and methods of using the device case and the lighting device.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the broad scope of the appended claims.

What is claimed is:

1. A photography lighting device for providing a lighting source to a mobile electronic device, the mobile electronic device having a front facing camera and a rearward facing camera, the lighting device comprising:
a case having a forward facing portion and an opposite rearward facing portion, at least part of the forward facing portion configured to receive at least a portion of the mobile electronic device;
a first light source movably connected to the case and movable from a first position to a second position, the first light source being rearward facing in the first position to provide illumination for the rearward facing camera, the first light source being forward facing in the second position to provide illumination for the forward facing camera;
a second light source movably connected to the case and movable from a first position to a second position, the second light source being rearward facing in the first position to provide illumination for the rearward facing camera, the second light source being forward facing in the second position to provide illumination for the forward facing camera;
a power source for providing power to the first light source and the second light source; and
control circuitry for controlling power provided to the first light source and the second light source.

2. The lighting device of claim 1, wherein the first light source and the second light source are movably connected to the case by at least one of friction, magnetism, resilient member(s), detent mechanism, springs, and torsion springs.

3. The lighting device of claim 1, wherein the first light source and the second light source include at least one of LED, COB LED, and OLED.

4. The lighting device of claim 1, wherein the case has a top and a bottom, the first light source being movably connected proximate to the top of the case and the second light source being movably connected proximate to the bottom of the case.

5. The lighting device of claim 1, further comprising a transceiver to communicate wirelessly with the mobile electronic device.

6. The lighting device of claim 5, wherein the transceiver utilizes Bluetooth to communicate wirelessly with the mobile electronic device.

7. The lighting device of claim 1, further comprising a connection adapter to be electronically coupled to a connection port of the mobile electronic device, thereby facilitating communication between the lighting device and the mobile electronic device.

8. The lighting device of claim 1, further comprising:
a first flap movably connected to the case and movable from a first position to a second position, the first flap including the first light source; and
a second flap movably connected to the case and movable from a first position to a second position, the second flap including the second light source.

9. The lighting device of claim 8, wherein the first light source and the second light source include a window for transmitting light.

10. The lighting device of claim 9, wherein the windows of the first light source and the second light source are at least one of translucent and a diffuser.

11. The lighting device of claim 1, wherein at least part of the case is configured to receive the first light source and the second light source when in the first position.

12. The lighting device of claim 1, wherein the case includes at least one finger notch adjacent to the first light source and the second light source when the first light source and the second light source are in the first position to assist in lifting the first light source and the second light source off of the case for movement to the second position.

13. A photography lighting device for providing a lighting source to a mobile electronic device, the mobile electronic device having a front, a front facing camera, a rear, and a rearward facing camera, the lighting device comprising:
a body having a forward facing portion and an opposite rearward facing portion, the forward facing portion configured to be removably attached to the rear of the mobile electronic device;
a first light source movably connected to the body and movable from a first position to a second position, the first light source being rearward facing in the first position to provide illumination for the rearward facing camera, the first light source being forward facing in the second position to provide illumination for the forward facing camera;
a second light source movably connected to the body and movable from a first position to a second position, the second light source being rearward facing in the first position to provide illumination for the rearward facing camera, the second light source being forward facing in the second position to provide illumination for the forward facing camera;
a power source for providing power to the first light source and the second light source; and
control circuitry for controlling power provided to the first light source and the second light source.

14. The lighting device of claim 13, wherein the first light source and the second light source are movably connected to the body by at least one of friction, magnetism, resilient member(s), detent mechanism, springs, and torsion springs.

15. The lighting device of claim 13, wherein the first light source and the second light source include at least one of LED, COB LED, and OLED.

16. The lighting device of claim 13, wherein the body has a top and a bottom, the first light source being movably connected proximate to the top of the body and the second light source being movably connected proximate to the bottom of the body.

17. The lighting device of claim 13, further comprising a transceiver to communicate wirelessly with the mobile electronic device.

18. The lighting device of claim 17, wherein the transceiver utilizes Bluetooth to communicate wirelessly with the mobile electronic device.

19. The lighting device of claim 13, further comprising a connection adapter to be electronically coupled to a connection port of the mobile electronic device, thereby facilitating communication between the lighting device and the mobile electronic device.

20. The lighting device of claim 13, further comprising:
a first flap movably connected to the body and movable from a first position to a second position, the first flap including the first light source; and
a second flap movably connected to the body and movable from a first position to a second position, the second flap including the second light source.

21. The lighting device of claim 20, wherein the first light source and the second light source include a window for transmitting light.

22. The lighting device of claim 21, wherein the windows of the first light source and the second light source are at least one of translucent and a diffuser.

23. The lighting device of claim 13, wherein at least part of the body is configured to receive the first light source and the second light source when in the first position.

24. The lighting device of claim 13, wherein the body includes at least one finger notch adjacent to the first light source and the second light source when the first light source and the second light source are in the first position to assist in lifting the first light source and the second light source off of the body for movement to the second position.

25. The lighting device of claim 13, wherein the forward facing portion of the body is configured to be removably attached to the rear of the mobile electronic device utilizing at least one of: two-sided tape, a magnet, hook and loop fasteners, a snap mechanism, an elastic strap, and a male member or female member of the body adapted to connect to a corresponding female member or male member of the mobile electronic device.
